(19) United States
(12) Patent Application Publication
(10) Pub. No.: US 2021/0163737 A1
(43) Pub. Date: Jun. 3, 2021

(54) POLY(ARYLENE ETHER KETONE) AND POLY(PHENYLENE ETHER) COMPOSITIONS, METHODS, AND ARTICLES

(71) Applicant: SHPP GLOBAL TECHNOLOGIES B.V., Bergen op Zoom (NL)

(72) Inventors: Fen ZHANG, Shanghai (CN); Mian DAI, Shanghai (CN); Liang SHEN, Shanghai (CN)

(21) Appl. No.: 17/267,101

(22) PCT Filed: Jul. 22, 2019
(86) PCT No.: PCT/IB2019/056258

§ 371 Date: Feb. 9, 2021

Related U.S. Application Data
(60) Provisional application No. 62/721,137, filed on Aug. 22, 2018.

(51) Int. Cl. C08L 71/12; C08G 65/40; C08G 65/48

(52) U.S. Cl. CPC C08L 71/126; C08G 2650/40; C08G 65/485; C08G 65/4012

(57) ABSTRACT

A thermoplastic composition includes 5-90 weight percent of poly(arylene ether ketone); 10-90 weight percent of poly(phenylene ether); 0-50 weight percent of an inorganic filler; and 0-5 weight percent of an additive composition, wherein the amount of each component is based on the total weight of the composition, and totals 100%.

### BACKGROUND

Poly(phenylene ether)s (PPE) have excellent dielectric properties and dimensional stability. Properties such as strength, stiffness, chemical resistance, and heat resistance can be tailored by blending PPE with various other polymers in order to meet the requirements of a wide variety of consumer products, including engineered plastics and high heat polymers. However, many current PPE compositions are less suitable for applications requiring resistance to high heat, such as in certain consumer electronics applications. Accordingly, there remains a continuing need in the art for improved PPE compositions having both good dielectric properties and heat performance for many industrial applications, especially in consumer electronics.

### BRIEF DESCRIPTION

In an aspect, a thermoplastic composition comprises 5-90 weight percent of poly(arylene ether ketone); 10-90 weight percent of poly(phenylene ether); 0-50 weight percent of an inorganic filler; and 0-5 weight percent of an additive composition, wherein the amount of each component is based on the total weight of the composition, and totals 100%.

In another aspect, an article comprises the above-described composition.

In yet another aspect, a method of making the article comprises blending the components of the above-described composition to provide a thermoplastic composition, and forming an article from the thermoplastic composition.

The above described and other features are exemplified by the following detailed description and examples.

### DETAILED DESCRIPTION

The present disclosure is related to thermoplastic compositions containing a combination of a poly(phenylene ether) (PPE) and a poly(arylene ether ketone) (PAEK). PPE is an amorphous engineering plastic that has very good dielectric performance; however, there remains a need for improved modulus, as well as continuous service temperature (i.e., heat resistance). PAEK is a semi-crystalline, high performance thermoplastic polymer having a very high continuous service temperature (>200° C.). However, the dielectric properties of PAEK are not acceptable for many applications. Unexpectedly, blends of PPE and PAEK can provide compositions with balanced dielectric properties and modulus performance, while maintaining the high continuous service temperature of PAEK. Specifically, the PAEK and PPE compositions have a low dielectric constant/dielectric tangent (Dk/Df) allowing for fast signal transmission, as well as good heat performance, which can satisfy cross-industry applications, such as in consumer electronics.

In an aspect, a thermoplastic composition comprises 5-90 weight percent (wt %) of poly(arylene ether ketone); 10-90 wt % of poly(phenylene ether); 0-50 wt % of an inorganic filler; and 0-5 wt % of an additive composition, wherein the amount of each component is based on the total weight of the composition, and totals 100%.

The composition comprises a poly(arylene ether ketone). A poly(arylene ether ketone) comprises repeating units of formulas (1) and (2)

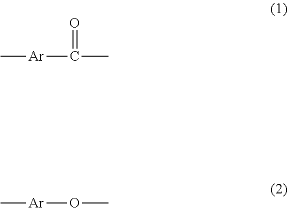

wherein Ar is independently at each occurrence a substituted or unsubstituted, monocyclic or polycyclic aromatic group having 6-30 carbons. Exemplary Ar groups include, but are not limited to, substituted or unsubstituted phenyl, tolyl, naphthyl, and biphenyl. Unsubstituted phenyl is preferred. In an aspect the poly(arylene ether ketone) comprises a poly(ether ketone).

A poly(ether ketone) comprise repeating units of formula (3)

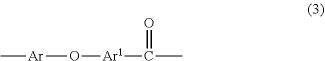

wherein Ar is defined as above and Ar¹ is independently at each occurrence a substituted or unsubstituted, monocyclic or polycyclic aromatic group having 6-30 carbons. Ar can be the same as or different from Ar¹. In an aspect Ar and Ar¹ are phenyl groups, preferably unsubstituted phenyl groups.

In an aspect the poly(arylene ether ketone) comprises a poly(ether ether ketone). A poly(ether ether ketone) comprises repeating units of formula (4)

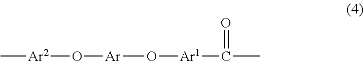

wherein Ar and Ar are defined as above. Ar² is independently at each occurrence a substituted or unsubstituted, monocyclic or polycyclic aromatic group having 6-30 carbons. Ar, Ar¹, and Ar² can be the same as or different from each other. Additionally, two of Ar, Ar¹, and Ar² can be the same as each other and the third can be different. In an aspect Ar, Ar¹, and Ar² are phenyl groups, preferably unsubstituted phenyl groups.

Poly(arylene ether ketone)s are generally known, with many examples being commercially available. Examples of commercially available aromatic polyketones include those sold under the trade name PEEK™, available from VICTREX.

In an aspect, the poly(arylene ether ketone) comprises a poly(ether ether ketone), a poly(ether ketone), a poly(ether ketone ketone), or a combination thereof, preferably a poly(ether ether ketone) of formula (4).

The composition comprises a poly(phenylene ether). Poly(phenylene ether)s include those comprising repeating structural units of formula (5)

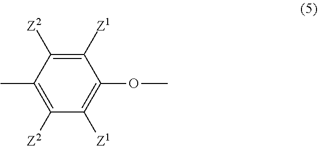

wherein each occurrence of Z¹ is independently halogen, unsubstituted or substituted C₁₋₁₂ hydrocarbyl provided that the hydrocarbyl group is not tertiary hydrocarbyl, C₁₋₁₂ hydrocarbylthio, C₁₋₁₂ hydrocarbyloxy, or C₂₋₁₂ halohydrocarbyloxy wherein at least two carbon atoms separate the halogen and oxygen atoms; and each occurrence of Z² is independently hydrogen, halogen, unsubstituted or substituted C₁₋₁₂ hydrocarbyl provided that the hydrocarbyl group is not tertiary hydrocarbyl, C₁₋₁₂ hydrocarbylthio, C₁₋₁₂ hydrocarbyloxy, or C₂₋₁₂ halohydrocarbyloxy wherein at least two carbon atoms separate the halogen and oxygen atoms. As used herein, the term “hydrocarbyl,” whether used by itself, or as a prefix, suffix, or fragment of another term, refers to a residue that contains only carbon and hydrogen. The residue can be aliphatic or aromatic, straight-chain, cyclic, bicyclic, branched, saturated, or unsaturated. It can also contain combinations of aliphatic, aromatic, straight chain, cyclic, bicyclic, branched, saturated, and unsaturated hydrocarbon moieties. However, when the hydrocarbyl residue is described as substituted, it may, optionally, contain heteroatoms over and above the carbon and hydrogen members of the substituent residue. Thus, when specifically described as substituted, the hydrocarbyl residue can also contain one or more carbonyl groups, amino groups, hydroxyl groups, or the like, or it can contain heteroatoms within the backbone of the hydrocarbyl residue. As one example, Z¹ can be a di-n-butylaminomethyl group formed by reaction of a terminal 3,5-dimethyl-1,4-phenyl group with the di-n-butylamine component of an oxidative polymerization catalyst.

The poly(phenylene ether) can comprise molecules having aminoalkyl-containing end group(s), typically located in a position ortho to the hydroxy group. Also frequently present are tetramethyldiphenoquinone (TMDQ) end groups, typically obtained from 2,6-dimethylphenol-containing reaction mixtures in which tetramethyldiphenoquinone by-product is present. The poly(phenylene ether) can be in the form of a homopolymer, a copolymer, a graft copolymer, an ionomer, or a block copolymer, as well as combinations thereof.

In an aspect, the poly(phenylene ether) comprises a poly(phenylene ether)-polysiloxane block copolymer. As used herein, the term “poly(phenylene ether)-polysiloxane block copolymer” refers to a block copolymer comprising at least one poly(phenylene ether) block and at least one polysiloxane block.

In an aspect, the poly(phenylene ether)-polysiloxane block copolymer is prepared by an oxidative copolymerization method. In this method, the poly(phenylene ether)-polysiloxane block copolymer is the product of a process comprising oxidatively copolymerizing a monomer mixture comprising a monohydric phenol and a hydroxyaryl-terminated polysiloxane. In an aspect, the monomer mixture comprises 70-99 parts by weight of the monohydric phenol and 1-30 parts by weight of the hydroxyaryl-terminated polysiloxane, based on the total weight of the monohydric phenol and the hydroxyaryl-terminated polysiloxane. The hydroxyaryl-diterminated polysiloxane can comprise a plurality of repeating units of formula (6)

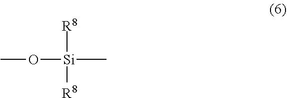

wherein each occurrence of R⁸ is independently hydrogen, C₁₋₁₂ hydrocarbyl or C₁₋₁₂ halohydrocarbyl; and two terminal units of formula (7)

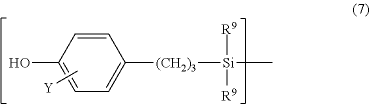

wherein Y is hydrogen, C₁₋₁₂ hydrocarbyl, C₁₋₁₂ hydrocarbyloxy, or halogen, and wherein each occurrence of R⁹ is independently hydrogen, C₁₋₁₂ hydrocarbyl or C₁₋₁₂ halohydrocarbyl. In an aspect, each occurrence of R⁸ and R⁹ is methyl, and Y is methoxy.

In an aspect, the monohydric phenol comprises 2,6-dimethylphenol, and the hydroxyaryl-terminated polysiloxane is of formula (8)

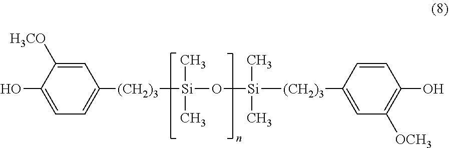

wherein n is, on average, 5-100, specifically 30-60.

The oxidative copolymerization method produces poly(phenylene ether)-polysiloxane block copolymer as the desired product and poly(phenylene ether) (without an incorporated polysiloxane block) as a by-product. It is not necessary to separate the poly(phenylene ether) from the poly(phenylene ether)-polysiloxane block copolymer. The poly(phenylene ether)-polysiloxane block copolymer can thus be utilized as a “reaction product” that includes both the poly(phenylene ether) and the poly(phenylene ether)-polysiloxane block copolymer. Certain isolation procedures, such as precipitation from isopropanol, make it possible to assure that the reaction product is essentially free of residual hydroxyaryl-terminated polysiloxane starting material. In other words, these isolation procedures assure that the polysiloxane content of the reaction product is essentially all in the form of poly(phenylene ether)-polysiloxane block copolymer. Detailed methods for forming poly(phenylene ether)-polysiloxane block copolymers are described in U.S. Pat. Nos. 8,017,697 and 8,669,332 to Carrillo et al.

In an aspect, the poly(phenylene ether) has an intrinsic viscosity of 0.25-1 deciliter per gram measured by Ubbelohde viscometer at 25° C. in chloroform. Within this range, the poly(phenylene ether) intrinsic viscosity can be 0.3-0.65 deciliter per gram, more specifically 0.35-0.5 deciliter per gram, even more specifically 0.4-0.5 deciliter per gram.

In an aspect, the poly(phenylene ether) comprises a homopolymer or copolymer of monomers selected from the group consisting of 2,6-dimethylphenol, 2,3,6-trimethylphenol, and combinations thereof. In an aspect, the poly(phenylene ether) comprises a poly(phenylene ether)-polysiloxane block copolymer. In an aspect, the poly(phenylene ether)-polysiloxane block copolymer can, for example, contribute 0.05-2 weight percent, specifically 0.1-1 weight percent, more specifically 0.2-0.8 weight percent, of siloxane groups to the composition as a whole.

Suitable poly(phenylene ether) homopolymers are commercially available as, for example, PPO™ 640 and 646 from SABIC, and XYRON™ S201A and S202A from Asahi Kasei Chemicals Corporation.

In an aspect, the poly(phenylene ether) comprises a poly(phenylene ether) homopolymer, a poly(phenylene ether-siloxane) block copolymer, or a combination of the poly(phenylene ether) homopolymer and the poly(phenylene ether-siloxane) block copolymer, wherein the combination has an intrinsic viscosity of 0.1-0.5 deciliter per gram, measured at 25° C. in chloroform, optionally wherein the poly(phenylene ether) is not modified with an epoxy compound.

The compositions optionally comprise an inorganic filler. The inorganic filler can be used to adjust the properties of the composition, for example modulus. When present, the inorganic filler can be used in an amount of up to 50 wt %, for example 0.1-50 wt %, preferably up to 20 wt %, for example 0.1-20 wt %. Exemplary inorganic fillers include glass fibers, carbon fibers or a combination thereof. In an aspect the inorganic filler and the amount of inorganic filler are selected to not significantly adversely impact the Dk or Df of the composition.

The compositions can also include effective amounts of an additive composition. The additive composition can include an additive as an anti-oxidant, thermal stabilizer, ultraviolet light absorber, processing aid, nucleation agent, flame retardant, drip retardant, dye, pigment, colorant, stabilizer, small particle mineral such as clay, mica, and talc, antistatic agent, plasticizer, lubricant, or a combination thereof. Effective amounts of the additive composition can vary widely, but can be present in an amount up to about 50 wt %, based on the weight of the entire composition. The additive composition is more typically present in an amount of 0.001 to 20 wt %, based on the total weight of the composition. Especially preferred additives include hindered phenols, thio compounds, and amides derived from various fatty acids. The preferred amounts of these additives generally ranges up to about 5 wt % total combined weight based on the total weight of the composition. In an aspect, the composition comprises 0.001 wt % to 5 wt % of each additive in the additive composition, based on the total weight of the composition.

In an aspect, the thermoplastic composition has a decrease in dielectric constant, dissipation factor, or both compared to the same composition with no poly(phenylene ether), as measured by ASTM D149. For example, a sample of the thermoplastic composition can have a decrease in dissipation factor of least 10% compared to the same composition with no added poly(phenylene ether). In an aspect, a, sample of the thermoplastic composition can have a decrease in dielectric constant of least 25% compared to the same composition with no added poly(phenylene ether).

In another aspect, the thermoplastic composition has a heat deflection temperature (HDT) greater than 150° C. as determined by ASTM D648 at 0.45 megaPascal at a thickness of 3.2 millimeters; or a molded sample of the composition has a lower specific gravity compared to the same composition with no added poly(phenylene ether), as measured by ASTM D792, preferably the specific gravity of the composition it at least 5% lower compared to the same composition with no added poly(phenylene ether).

In yet another aspect, the composition has an increase in flexural modulus, tensile modulus, or both, compared to the same composition with no added poly(arylene ether ketone).

Also included are articles comprising the thermoplastic compositions described herein. Such articles can be, for example, computer and business machine housings such as housings for monitors, handheld electronic device housings such as housings for cell phones, electrical connectors, and components of lighting fixtures, ornaments, home appliances, roofs, greenhouses, sun rooms, swimming pool enclosures, thin walled articles such as housing for electronic devices and the like. Additional examples of articles that can be formed from the compositions include electrical parts, such as relays, and enclosures, consumer electronics such as enclosures and parts for laptops, desktops, docking stations, personal digital assistants (PDAs), digital cameras, desktops, and telecommunications parts such as parts for base station terminals. Further examples of articles that can be formed from compositions include light guides, light guide panels, lenses, covers, sheets, films, and the like, e.g., LED lenses, LED covers, and so forth.

In an aspect the article is a dielectric layer for a circuit. Optionally the dielectric layer can further include a woven or nonwoven web, for example a reinforcing nonwoven glass web.

Shaped, formed, or molded articles comprising the thermoplastic compositions are also provided, according to an aspect. A method of making an article comprises blending the components of the thermoplastic composition described herein to provide a thermoplastic composition, and forming an article from the thermoplastic composition. The thermoplastic compositions can be molded into useful shaped articles by a variety of means such as injection molding, extrusion, compression molding, rotational molding, blow molding, or thermoforming.

The disclosure and claims are further illustrated by the following Examples.

### EXAMPLES

### Example 1

The examples were prepared using the components in Table 1.

TABLE 1

| Component | Description |
|---|---|
| PEEK | Poly(phenylene ether ether ketone), CAS Number: |
| | 29658-26-2 or 31694-16-3, supplied by Jilin Joinature |
| | Polymer Co., Ltd. Grade name 770G, having MFI of |
| | 10 g/10 min at 380 C./5 kg, measured by ISO 1133 |
| PPE | Poly(2,6-dimethyl-1,4-phenylene ether), CAS Reg. |
| | No. 25134-01-4, having an intrinsic viscosity of |
| | 0.46 deciliter per gram measured in chloroform at 25° C. |
| | and a weight average molecular weight of 66,000 daltons; |
| | obtained as PPO 646 from SABIC. |

Compositions were prepared by compounding on a twin screw extruder. All polymers were blended together and fed by the main feeder. The extruded strand of composition was cut into pellets and dried for further molding and evaluation. The testing was conducted on pellets and molded parts. The compounding profile is provided in Table 2 and the injection molding profile is provided in Table 3.

TABLE 2
Compounding Profile

| Parameters | Unit | Set Values |
|---|---|---|
| Zone 1 Temperature | ° C. | 50 |
| Zone 2 Temperature | ° C. | 150 |
| Zone 3 Temperature | ° C. | 350 |
| Zone 4 Temperature | ° C. | 360 |
| Zone 5 Temperature | ° C. | 360 |
| Zone 6 Temperature | ° C. | 380 |
| Zone 7 Temperature | ° C. | 380 |
| Zone 8 Temperature | ° C. | 380 |
| Zone 9 Temperature | ° C. | 380 |
| Zone 10 Temperature | ° C. | 380 |
| Zone 11 Temperature | ° C. | 380 |
| Die Temperature | ° C. | 380 |
| Screw speed | rpm | 400 |
| Throughput | kg/hr | 20 |

TABLE 3
Injection Molding Profile

| Parameters | Unit | Set Values |
|---|---|---|
| Cnd: Pre-drying time | Hour | 4 |
| Cnd: Pre-drying temp | ° C. | 150 |
| Hopper temp | ° C. | 70 |
| Zone 1 temp | ° C. | 360 |
| Zone 2 temp | ° C. | 370 |
| Zone 3 temp | ° C. | 375 |
| Nozzle temp | ° C. | 380 |
| Mold temp | ° C. | 180 |

Testing of the compositions was performed by the following methods. All methods are those in effect as of Jan. 31, 2017.

Melt volume rate (MVR) (ASTM D1238): The pellets were pre-dried at 135° C. for 4 hours. The test condition was 400° C., 2.16 kilogram (kg) with dwell time of 300 seconds (s).

Heat deflection temperature (HDT) (ASTM D648): The testing stress was 0.45 MPa and the specimen thickness was 3.2 mm.

Tensile strength (ASTM D638): The test speed was 5 millimeters per minute (mm/min).

Flexural properties (ASTM D790): The test speed was 1.27 mm/min.

Dielectric Strength (ASTM D149): Dielectric constant (Dk) and dissipation factor (Df) were tested at 5 GHz.

Specific gravity (S.G.) (ASTM D792): A molded Izod bar was used for the test.

Table 4 shows the compositions and properties for the compositions made of PEEK and PPE in different ratios, wherein amounts are in weight percent, based on the total weight of the polymer. The test compositions contained no additives or fillers.

TABLE 4
Compositions and Properties

| Component | Units | Ex. 1* | Ex. 2 | Ex. 3 | Ex. 4* |
|---|---|---|---|---|---|
| PPE | Wt % | 0 | 20 | 80 | 100 |
| PEEK | Wt % | 100 | 80 | 20 | 0 |
| Properties | | | | | |
| MVR | cm³/10 min | 3.6 | 7.6 | 54.9 | — |
| SG | — | 1.3 | 1.26 | 1.12 | 1.06 |
| Dk, 5 GHz | — | 3.14 | 3.13 | 2.72 | 2.6 |
| Df, 5 GHz | — | 0.0055 | 0.00419 | 0.00392 | 0.0005 |
| HDT | ° C. | 148 | 161 | 201 | 190 |
| Flexural Modulus | MPa | 3120 | 3160 | 2690 | 2300 |
| Tensile Modulus | MPa | 3470 | 3328 | 2679 | 2133 |

*Comparative examples

As can be seen from Table 4, the modulus (flexural and tensile) and long term heat resistance performance (HDT) are acceptable for PEEK (Ex. 1), but the dielectric properties, particular the Df, are not acceptable. To improve the dielectric property of pure PEEK, PPE was selected to lower the Dk and Df performance.

As the PPE content increases from 20 wt % to 80 wt % (Ex, 3 and 4), the MVR performance improves, the specific gravity decreases, and the Dk and Df values decrease. The HDT performance also shows an increase with PPE loading of 20 or 80%. As the PEEK loading amount increases, the modulus (tensile, flexural) performance of the compositions increase.

Thus, as shown in Table 4, the combination of PPE to PEEK provides compositions with improved dielectric performance and HDT performance, and lower specific gravity performance. In addition, PEEK balances the modulus performance of the compositions. The new compositions containing PAEK and PPE advantageously demonstrate improved dielectric properties and heat performance, with a lowering in the specific gravity performance.

This disclosure further encompasses the following non-limiting aspects.

Aspect 1: A thermoplastic composition comprising 5-90 wt % of poly(arylene ether ketone); 10-90 wt % of poly(phenylene ether); 0-50 wt % of an inorganic filler; and 0-5 wt % of an additive composition, wherein the amount of each component is based on the total weight of the composition, and totals 100%.

Aspect 2: The thermoplastic composition of aspect 1, wherein the poly(arylene ether ketone) comprises a poly(ether ether ketone), a poly(ether ketone), a poly(ether ketone ketone), or a combination thereof, preferably a poly(ether ether ketone).

Aspect 3: The thermoplastic composition of any one or more of aspects 1 or 2, wherein the poly(phenylene ether) comprises a poly(phenylene ether) homopolymer, a poly(phenylene ether-siloxane) block copolymer, or a combination of the poly(phenylene ether) homopolymer and the poly(phenylene ether-siloxane) block copolymer, wherein the combination has an intrinsic viscosity of 0.1-0.5 deciliter per gram, measured at 25° C. in chloroform, optionally wherein the poly(phenylene ether) is not modified with an epoxy compound.

Aspect 4: The thermoplastic composition of any one or more of aspects 1-3, comprising 0.1 wt %-50 wt % of the inorganic filler, preferably 0.1 wt %-20 wt % of the inorganic filler.

Aspect 5: The thermoplastic composition of aspect 4, wherein the inorganic filler comprises glass fibers, carbon fibers or a combination thereof.

Aspect 6: The thermoplastic composition of any one or more of aspects 1-5, comprising 0.001 wt %-5 wt % of the additive.

Aspect 7: The thermoplastic composition of aspect 6, wherein the additive comprises an antioxidant, a thermal stabilizer, an ultraviolet light absorber, a processing aid, a nucleation agent, or a combination thereof.

Aspect 8: The thermoplastic composition of any one or more of aspects 1-7, having a decrease in dielectric constant and dissipation factor compared to the same composition with no added poly(phenylene ether), as measured by ASTM D149, preferably a decrease in dissipation factor of least 10% compared to the same composition with no added poly(phenylene ether).

Aspect 9: The thermoplastic composition of any one or more of aspects 1-8, wherein a heat deflection temperature of the thermoplastic composition is greater than 150° C. as determined by ASTM D648 at 0.45 megaPascal at a thickness of 3.2 millimeters; or a molded sample of the composition has a lower specific gravity compared to the same composition with no added poly(phenylene ether), as measured by ASTM D792, preferably the specific gravity of the composition it at least 5% lower compared to the same composition with no added poly(phenylene ether).

Aspect 10: The thermoplastic composition of any one or more of aspects 1-9, wherein the composition has an increase in flexural modulus, tensile modulus, or both, compared to the same composition with no added poly(arylene ether ketone).

Aspect 11: An article comprising the thermoplastic composition of any one or more of aspects 1-10.

Aspect 12: The article of aspect 11, wherein the article comprises a dielectric layer for a circuit.

Aspect 13: A method of making an article comprising, blending the components of the composition of any one or more of aspects 1-10 to provide a thermoplastic composition, and forming an article from the thermoplastic composition.

Aspect 14: The method of aspect 13, wherein forming is by extrusion, injection molding, or compression molding.

The assemblies, methods, and devices can alternatively comprise, consist of, or consist essentially of, any appropriate components or steps herein disclosed. The assemblies, methods, and devices can additionally, or alternatively, be formulated so as to be devoid, or substantially free, of any steps, components, materials, ingredients, adjuvants, or species that are otherwise not necessary to the achievement of the function or objectives of the assemblies, methods, and devices. All ranges disclosed herein are inclusive of the endpoints, and the endpoints are independently combinable with each other. “Combinations” is inclusive of blends, mixtures, alloys, reaction products, and the like. “Combination thereof” is open, in that the combination can include like elements not named. The terms “a” and “an” and “the” do not denote a limitation of quantity, and are to be construed to cover both the singular and the plural, unless otherwise indicated herein or clearly contradicted by context. “Or” means “and/or” unless clearly stated otherwise. Reference throughout the specification to “some aspects,” “an aspect,” and so forth, means that a particular element described in connection with the aspect is included in at least some aspects described herein, and may or may not be present in other aspects. In addition, it is to be understood that the described elements may be combined in any suitable manner in the various aspects.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

While particular aspects have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A thermoplastic composition comprising
5-90 weight percent of poly(arylene ether ketone);
10-90 weight percent of poly(phenylene ether);
0-50 weight percent of an inorganic filler; and
0-5 weight percent of an additive composition,
wherein the amount of each component is based on the total weight of the composition, and totals 100%.

2. The thermoplastic composition of claim 1, wherein
the poly(arylene ether ketone) comprises a poly(ether ether ketone), a poly(ether ketone), a poly(ether ketone ketone), or a combination thereof,
preferably a poly(ether ether ketone).

3. The thermoplastic composition of claim 1, wherein
the poly(phenylene ether) comprises a poly(phenylene ether) homopolymer, a poly(phenylene ether-siloxane) block copolymer, or
a combination of the poly(phenylene ether) homopolymer and the poly(phenylene ether-siloxane) block copolymer, wherein the combination has an intrinsic viscosity of 0.1-0.5 deciliter per gram, measured at 25° C. in chloroform, optionally wherein the poly(phenylene ether) is not modified with an epoxy compound.

4. The thermoplastic composition of claim 1, comprising an organic filler in an amount of up to 50 weight percent of the inorganic filler, preferably up to 20 weight percent of the inorganic filler.

5. The thermoplastic composition of claim 4, wherein the inorganic filler comprises glass fibers, carbon fibers or a combination thereof.

6. The thermoplastic composition of claim 1, comprising 0.001-5 weight percent of each additive in the additive composition.

7. The thermoplastic composition of claim 6, wherein the additive comprises an antioxidant, a thermal stabilizer, an ultraviolet light absorber, a processing aid, a nucleation agent, or a combination thereof.

8. The thermoplastic composition of claim 1, having a decrease in dielectric constant and dissipation factor compared to the same composition with no added poly(phenylene ether), as measured by ASTM D149, preferably a decrease in dissipation factor of least 10% compared to the same composition with no added poly(phenylene ether).

9. The thermoplastic composition of claim 1, wherein
a heat deflection temperature of the thermoplastic composition is greater than 150° C. as determined by ASTM D648 at 0.45 megaPascal at a thickness of 3.2 millimeters; or
a molded sample of the composition has a lower specific gravity compared to the same composition with no added poly(phenylene ether), as measured by ASTM D792, preferably the specific gravity of the composition it at least 5% lower compared to the same composition with no added poly(phenylene ether).

10. The thermoplastic composition of claim 1, wherein the composition has an increase in flexural modulus, tensile modulus, or both, compared to the same composition with no added poly(arylene ether ketone).

11. An article comprising the thermoplastic composition of claim 1.

12. The article of claim 11, wherein the article comprises dielectric layer for a circuit.

13. A method of making an article comprising,
blending the components of the composition of claim 1 provide a thermoplastic composition, and
forming an article from the thermoplastic composition.

14. The method of claim 13, wherein forming is by extrusion, injection molding, or compression molding.
